(19) United States
(12) Patent Application Publication
(10) Pub. No.: US 2010/0072977 A1
(43) Pub. Date: Mar. 25, 2010

(54) ELECTRONIC DEVICE AND TEST METHOD OF ELECTRONIC DEVICE

(75) Inventors: Teruaki YAGOSHI, Kawasaki (JP); Hitoshi YOKEMURA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/629,167

(22) Filed: Dec. 2, 2009

Related U.S. Application Data
(63) Continuation of application No. PCT/JP2007/061816, filed on Jun. 12, 2007.

(51) Int. Cl. G01D 1/14

(52) U.S. Cl. 324/76.13

(57) ABSTRACT

An electronic device includes a receiver receiving a signal, a driver outputting a signal, and at least one of an amplitude measuring device having an amplitude detector connected to an input end of the receiver and a jitter measuring device having a phase detector connected to an output end of the receiver. An output end of the driver and an input end of the receiver are connected to measure at least one of the amplitude and jitter of the driver output.

### CROSS-REFERENCE TO RELATED APPLICATION

This application is a continuation application and is based upon PCT/JP2007/61816, filed on Jun. 12, 2007, the contents being incorporated herein by reference.

### FIELD

The present invention relates to an electronic device in high speed operation which is able to run tests for measuring the characteristics of the device, a test method for the electronic device and method of production of the electronic device.

### BACKGROUND

In recent years, due to the spread of broadband Internet services, not only faster speed and large capacity networks, but also faster speed electronic circuits and electronic devices are being sought inside communication devices, servers, and storages. Among such electronic circuits, for example, input/output circuits (I/O), various types of high speed I/O's are being developed. The “high speed I/O's” generally mean input-output circuits incorporated in integrated circuits (LSI) which have a speed of a data rate of 1 Gbps or more. It is difficult to test such high speed I/O's due to their high speed operation. Even if using an external circuit to try to input test signals, there are limits to the input frequency (several 100 MHz) and input signal (DC input). Therefore, the test using the external circuit is not effective as a test for high speed I/O's. Conventionally, a BIST (built-in self-test) circuit is embedded in integrated circuits and just a connectivity test is run by the BIST circuit.

In some cases, an integrated circuit judged good in the connectivity test will not enable normal conductivity after being assembled in a module, due to characteristics of the assembled circuit and signal loss due to the board etc. Furthermore, even if trying to develop an external test system enabling not only conductivity test, but also measurement of the amplitude of input-output signals or confirmation of jitter tolerance, the cost would be too high and the system would not be practical. Note that for measurement of jitter, the art described in the following Patent documents 1 and 2 is known. For loopback tests, the art described in the following Patent document 3 is known.

Patent document 1: Japanese Patent No. 3724803

Patent document 2: Japanese Laid-Open Utility Model Publication No. 5-41232

Patent document 3: Japanese Laid-Open Patent Publication No. 2004-328369

### SUMMARY

One aspect of the present embodiments provides an electronic device which includes a receiver receiving a signal, a driver outputting a signal, and at least one of an amplitude measuring device having an amplitude detector connected to an input end of the receiver and a jitter measuring device having a phase detector connected to an output end of the receiver, wherein an output end of the driver and an input end of the receiver are connected so as to measure at least one of amplitude and jitter of a driver output.

A second aspect of the present embodiments provides a test method for an electronic device which includes with a receiver receiving a signal, a driver outputting a signal, and at least one of an amplitude measuring device having an amplitude detector connected to an input end of the receiver and a jitter measuring device having a phase detector connected to an output end of the receiver, the test method including: connecting an output end of the driver and an input end of the receiver, outputting a signal from the driver, measuring an amplitude of the signal output from the driver by the amplitude measuring device, if the amplitude measuring device is provided, and, measuring the jitter of the signal output from the driver by the jitter measuring device, if the jitter measuring device is provided.

According to a third aspect of the present embodiments, there is provided a machine-readable storage medium storing a computer program to perform a test method for an electronic device, the electronic device including a receiver receiving a signal, a driver outputting a signal, and at least one of an amplitude measuring device having an amplitude detector connected to an input end of the receiver and a jitter measuring device having phase detectors connected to an output end of the receiver, the method performed after connecting the input end of the receiver and the output end of the driver, the method including: outputting a signal from the driver and measuring at least one of an amplitude and phase of the signal output from the driver by at least one of the amplitude measuring device connected to the input end of the receiver and the jitter measuring device connected to the output end of the receiver.

### BRIEF DESCRIPTION OF DRAWINGS

FIG. 1 is a view for explaining measurement of amplitude according to a first embodiment.

FIG. 2 is a view for explaining an example of a loopback circuit used in an embodiment.

FIG. 3 is a view for explaining measurement of jitter according to a second embodiment.

FIG. 4 is a view for explaining check of a minimum input amplitude value according to a third embodiment and check of an input jitter tolerance according to a fourth embodiment.

FIG. 5 is a circuit for calibration of a driver output according to an embodiment.

FIG. 6 is a circuit for calibration of an amplitude detector according to an embodiment.

FIG. 7 is a circuit for calibration of phase detectors according to an embodiment.

FIG. 8 is circuit for calibration of a delay controller according to an embodiment.

FIG. 9 is a block diagram illustrating an outline according to an embodiment.

FIG. 10 is view for explaining the method of production of an integrated circuit according to an embodiment.

FIG. 11 is a view for explaining a package included a printed circuit board on which the integrated circuit according to an embodiment is mounted.

### DESCRIPTION OF EMBODIMENTS

Below, embodiments will be explained with reference to the drawings. In the drawings, the same reference notations show the same components.

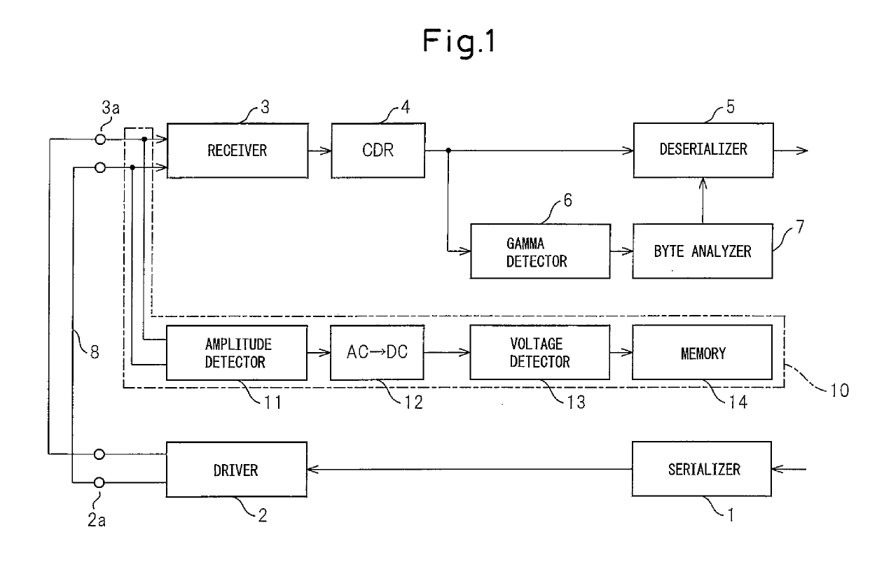

FIG. 1 is a view illustrating a high speed I/O (Input/Output circuit) having an output amplitude measuring device according to a first embodiment. An output amplitude measuring unit is built into the integrated circuit by a semiconductor process as part of the integrated circuit along with the high speed I/O.

In an output unit of the high speed I/O, a serializer 1 is used to convert parallel data to serial data, then an driver 2 outputs the serial data.

Further, in an input unit of the high speed I/O, a receiver 3 is used to receive serial data. The receiver 3 outputs the serial data which is then input to a CDR (Clock Data Recovery) 4 for extracting the clock. The clock extracted from the CDR 4 is input through a gamma detector 6 to a word aligner or byte aligner 7.

On the other hand, the serial data output from the CDR 4 is input to a deserializer 5. The deserializer 5 is controlled by the byte aligner 7 so that the timings of the parallel data of the deserializer 5 are aligned and converts the serial data to parallel data.

The above configurations of the input unit and output unit of the high speed I/O are known. In a first embodiment, the input unit and the output unit of the high speed I/O are made to connect each other. That is, the output end 2a of the driver 2 and the input end 3a of the receiver 3 are connected by a loopback circuit 8 to input the output of the output driver 2 to the receiver 3. Furthermore, an output amplitude measuring device 10 connected to the input end 3a of the receiver 3 is provided.

The output amplitude measuring device 10 has an amplitude detector 11 connected to the input end 3a of the receiver 3, an AC-DC converter 12 converting the AC output corresponding to the amplitude output from the amplitude detector 11 to DC, a voltage detector 13 converting the output of the AC-DC converter 12 to voltage, and a memory 14 storing the output of the voltage detector 13.

As illustrated in FIG. 1, the loopback circuit 8 can be configured by wiring provided outside the integrated circuit. However, the loopback circuit 8 may also be configured integrally with the integrated circuit by a circuit such as a printed interconnect formed in an integrated circuit.

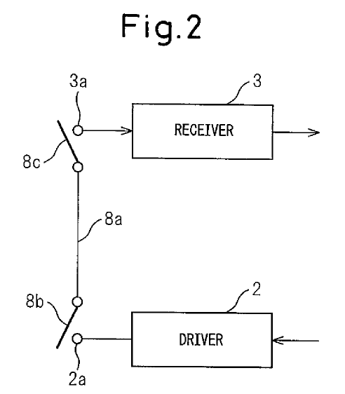

FIG. 2 is a view for explaining a loopback circuit provided in an integrated circuit. In FIG. 2, to facilitate the explanation, the loopback circuit in the integrated circuit corresponding to the loopback circuit 8 illustrated by the double lines in FIG. 1 is shown by single lines.

As illustrated in FIG. 2, an interconnect 8a is provided in the integrated circuit and the output end 2a of the driver 2 and the input end 3a of the receiver 3 are connected to the interconnect 8a via switches 8b and 8c such as semiconductor switches. By turning the switches 8b and 8c ON, a loopback circuit is formed for testing. Note that in other embodiments as well, whether to employ an external loopback circuit 8 or to employ an internal loopback circuit 8a can be selected in accordance with need.

In the first embodiment, a loopback circuit is formed to connect the output of the driver 2 and the input of the receiver 3. Then the output driver 3 outputs the alternating 01 serial data. The output alternating 01 serial data is input to the receiver 3 and the amplitude detector 11. The amplitude detected by the amplitude detector 11 is input to the AC-DC converter 12 to convert to a DC signal. The converted DC signal is input to the voltage detector 13 to detect the voltage. The detected voltage is stored in the memory 14 as amplitude information and is judged as to whether it is in the range of a rated value.

By doing this, while only conductivity could be tested in the past, it becomes possible to quantitatively test the signal amplitude. Further, even if some inconvenience occurs in tests after mounting a plurality of integrated circuits on a board, identifying which integrated circuit is defective becomes easy.

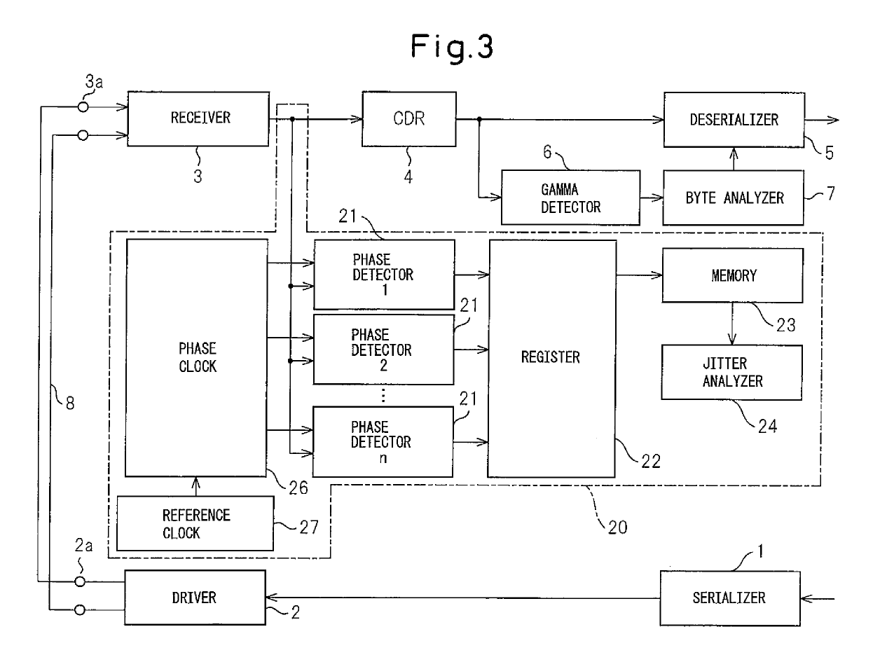

A second embodiment measures the offset in edge occurring in a bit train of data, that is, the “jitter”. FIG. 3 illustrates a high speed I/O provided with a jitter measuring device measuring the output jitter according to the second embodiment. The jitter measuring device is incorporated as part of the integrated circuit together with the high speed I/O.

The high speed I/O of the second embodiment is also provided with an input unit and output unit similar to the first embodiment. In the second embodiment, a jitter measuring device 20 connected to the output of the receiver 3 of the input unit. The jitter measuring device 20 is provided with n number of phase detectors 21 to first inputs of which the output of the receiver 3 is connected, a phase clock generator 26 connected to the other input ends of the n number of phase detectors 21, a register 22 to which the outputs of the n number of phase detectors 21 are input, a memory 23 in which the output of the register 22 is stored, and a jitter analyzer 24 connected to the memory 23. Further, the phase clock generator 26 has a reference clock generator 27 connected to it generating a reference clock serving as reference of the phase clocks.

To measure the output jitter, first, the output end 2a of the driver 2 and the input end 3a of the receiver 3 are connected by loopback connection to make the output of the driver 2 be input to the receiver 3. The driver 2 outputs predetermined alternating 01 data. the output from the receiver 3 receiving data from the driver 3 is input to the CDR 4 and input to one of the input ends of the n number of phase detectors 21. At the other input ends of the n number of phase detectors 21, phase clocks having a phase difference of 0.01UI (Unit Intervals) are input from the phase clock generator 26. The phase clock generator 26 generates phase clocks given to the phase detectors based on the reference clock input from the reference clock generator 27. The reference clock generator 27 may be arranged outside the integrated circuit, but in the present embodiment one inside the integrated circuit is utilized.

When the phase clocks having the 0.01UI worth of phase difference are input to the n number of phase detectors 21, every 0.01UI worth of data of the receiver 3 is detected. The detected data temporarily is stored in the register 22, and then in the memory 23. The process of phase detection by the phase detector 21, the temporary storage by the register 22, and the storage in the memory is performed several hundred times, then the information stored in the memory 23 is read out and the jitter analyzer is used to calculate the amount of jitter. The calculated amount of jitter can be compared with a predetermined reference jitter amount and judged as to whether being good or no good. Note that the calculated amount of jitter may for example be stored in a memory in an output port (not shown) or may be returned to the memory 23 for storage.

In the second embodiment, it is possible to measure jitter which could not be measured in the past. Further, in tests after mounting a plurality of integrated circuits on a board, identification of which integrated circuits are defective becomes easy.

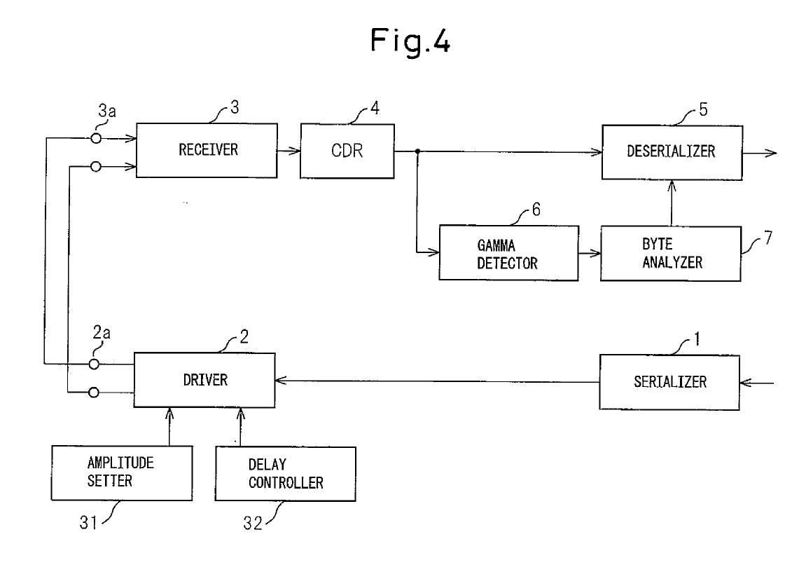

FIG. 4 is a view illustrating a method to check the minimum input amplitude value as a third embodiment and a method to check an input jitter tolerance as a fourth embodiment.

In the third embodiment, the minimum input amplitude value of the receiver 3 is checked. For the check, an amplitude setter 31 to set an output amplitude of the driver 2 is provided. The amplitude setter 31 can also set an output amplitude of the driver to become outside the range of the rated value of the receiver 3. Further, the output end 2a of the driver 2 and the input end 3a of the receiver 3 are connected by loopback connection to make the output of the driver 2 be input to the receiver 3.

Next, the driver 2 is driven to output predetermined data from the driver 2. After this, the amplitude setter 31 is used to set the output amplitude of the driver 2 so that the input signal to the receiver 3 becomes the minimum input amplitude value of the receiver 3. In this state, whether the output from the driver 2 passes through the receiver 3 is checked. Thus, a signal conductivity test is performed.

The fourth embodiment is a method to check the jitter tolerance showing the ability of the receiving side to track jitter without causing a drop in the bit error rate. In the fourth embodiment, a delay controller 32 is provided to control the amount of delay of the driver 2. This delay controller 32 can also set the amount of delay of the driver output so as to be outside the range of the rated value of the receiver 3. Further, the output end 2a of the driver 2 and the input end 3a of the receiver 3 are connected by loopback connection to make the output of the driver 2 be input to the receiver 3.

Next, the driver 2 is driven to output predetermined data from the driver 2. After this, a delay control means 32 is used to give jitter to the output signal of the driver 2 so that the input signal to the receiver 3 has the maximum jitter allowed by the receiver 3. In this state, whether the output from the driver 2 passes through the receiver 3 is checked. Thus, a signal conductivity test is performed.

In the third and fourth embodiments, it is possible to check the minimum input amplitude value and maximum input jitter tolerance—neither of which were possible in conventional conductivity tests.

Above, embodiments of the present invention enabling shipment tests were explained. Next, calibration by an embodiment will be explained. According to this embodiment, calibration is possible by inputting a reference signal from the outside.

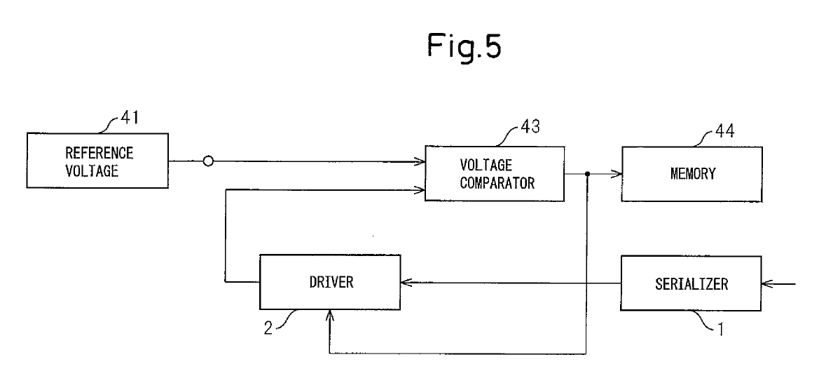

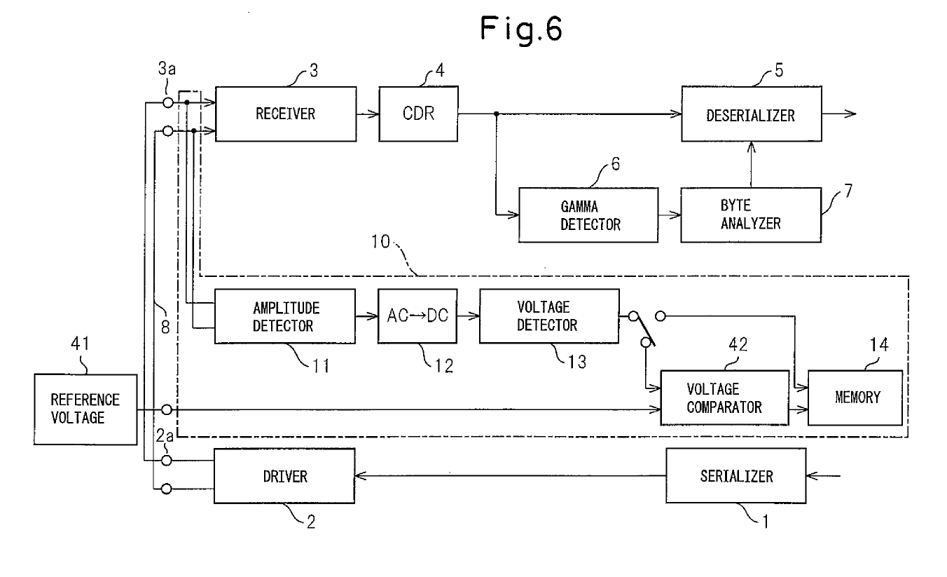

FIG. 5 is a view illustrating calibration of driver output predicated on calibration of an output amplitude detector of an output amplitude measuring device. FIG. 6 is a view explaining calibration of the output amplitude detector of the output amplitude measuring device. Before calibrating the output amplitude detector 11, the driver 2 has to be calibrated, so first calibration of the driver output will be explained with reference to FIG. 5.

As illustrated in FIG. 5, a voltage comparator 43 is provided for calibrating the output of the driver 2. The voltage comparator 43 receives as input the voltage output from the driver 2 and an external reference voltage output from an external reference voltage generation circuit 41. The output of the voltage comparator 43 is stored in a memory 44. Note that in place of the voltage comparator 43 and the memory 44, the voltage comparator 42 and memory 14 as illustrated in FIG. 6 may also be used.

The output of the driver 2 is calibrated as follows. On the one hand, the reference voltage output from the external reference voltage generator 41 is input to one input terminal of the voltage comparator 42. On the other hand, the driver 2 outputs a DC signal of the H level by a similar voltage setting as the reference voltage. The DC signal is input to the other input terminal of the voltage comparator 42. The voltage comparator 42 compares the reference voltage and the output voltage of the driver 2. If the result is that there is error, the setting of the driver 42 is changed. If a setting is found not to give error, the found setting is stored in the memory 14.

When the amplitude of the output of the driver 2 is set, it is possible to use the error-free setting stored in the memory 14 so that the output driver 2 outputs voltage the same as the reference voltage output from the reference voltage generator 41.

Next, referring to FIG. 6, calibration of the amplitude detector 11 will be explained. For calibration, a voltage comparator 42 is provided at the input amplitude measuring device 10. The voltage comparator 42 is provided with two input terminals. One input terminal receives a voltage from the voltage detector 13, which voltage corresponds to the output amplitude of the driver 2 detected by the amplitude detector 11 and, the other terminal receives the reference voltage output from the external reference voltage generator 41.

To calibrate the amplitude detector 11, loopback connection is used to connect the output of the driver 2 and the input of the receiver 3, and comparing a voltage output from the driver 2 with the reference voltage output from the reference voltage generator 41.

The driver 2 is adjusted in view of the results of calibration of FIG. 5 to output AC data of alternating 01 so that an output voltage similar to the reference voltage is given. The output end 2a of the driver 2 and the input end 3a of the receiver 3 are connected by loopback connection, so the output of the driver 2 is input to the receiver 3 and input to the amplitude detector 11.

The amplitude detected by the amplitude detector 11 is converted to DC output by the AC-DC converter 12 and its voltage is detected by the voltage detector 13. The voltage detected by the voltage detector 13 is input to one of the input ends of the voltage comparator 42, while the reference voltage output from the external reference voltage generator 41 is input to the other input end of the voltage comparator 42. In this way, the voltage detected by the voltage detector 13 and the external reference voltage are compared by the voltage comparator 42. The result of the comparison, that is, the difference of the voltages, is stored in the memory 14. After this, the voltage value detected by the voltage detector 13 is corrected by the stored difference, of the voltages.

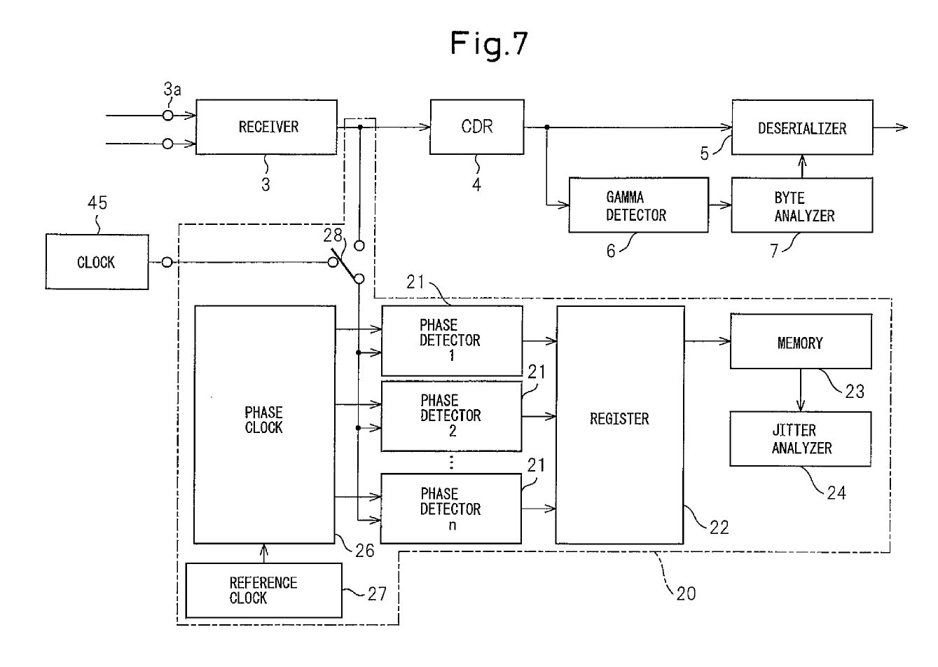

FIG. 7 is a view explaining calibration of the phase detectors 21 of the jitter measuring device 20. To calibrate the phase detectors 21, switch 28, for example, a semiconductor switch, is placed in a signal path from the receiver 3 to the n number of phase detectors 21 in the phase detection unit 20. The switch 28 switches between a signal from the receiver 3 and an external clock from an external clock generator 45 and inputs either to the n number of phase detectors 21. The external clock generator 45 outputs a clock having a predetermined phase difference from the reference clock output from the reference clock generator 27.

The phase detectors 21 are calibrated as follows. A clock having a predetermined phase difference from a reference clock output from the reference clock generator 27 is input from the external clock generator 45 to first ends of the n number of phase detectors. The phase detectors 21 receive clocks having 0.01UI worth of phase difference from the phase clock generator 26 at their other ends, so the phase detectors 21 detect the differences in the phases. The phase differences detected by the phase detectors 21 are stored through the register 22 in the memory 23. The phase differences stored in the memory 32 are used by the jitter analyzer 24 to calculate the error from the clock from the external clock generator 45. The calculated error is used for correction of the output of the jitter measuring device 20.

When the phase detectors 21 finish being calibrated, the delay controller 32 giving the output jitter can be calibrated.

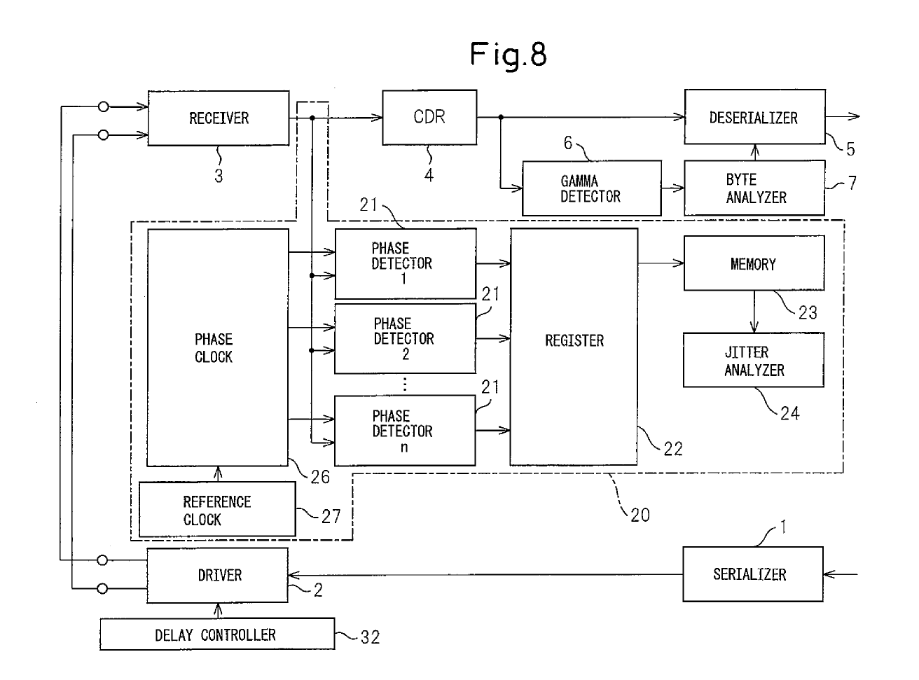

FIG. 8 is a view explaining calibration of a delay controller giving the output jitter. When the phase detectors 21, that is, the receiving side jitter detectors, finish being calibrated, next the output jitter controller, that is, the delay controller 32, can be calibrated. Note that FIG. 7 differs compared with FIG. 2 only in the point of the delay controller 32 being added.

The output end 2a of the driver 2 and the input end 3a of the receiver 3 are connected by loopback connection so that the output of the driver 2 is input to the receiver 3. The delay controller 32 controlling the delay of the output driver 2 gives the output signal a jitter of exactly a predetermined value and makes the output driver 2 output a signal.

As explained with reference to FIG. 3, the output from the receiver 3 is compared with phase clocks having 0.01UI (Unit Interval) worth of phase differences from the n number of phase detectors 21. The results are stored through the register 22 in the memory 23. Based on information relating to the jitter stored in the memory 23, the jitter analyzer 24 calculates the amount of jitter. The calculated jitter of the delay control circuit 32 is compared with the jitter of the phase detectors finished being calibrated, then the detected errors are stored in a memory such as the memory 23 and used for correction of the control value of the delay controller.

In the past, produced electronic circuits were only able to be tested for signal conductivity, but according to the embodiments, it is possible to measure the electronic circuit for amplitude or jitter, so it is possible to judge if specifications are satisfied before shipment. Furthermore, if providing a driver amplitude setter, it is also possible to check the minimum input amplitude value. Further, if providing a driver delay controller, it is also possible to check the input jitter tolerance. Furthermore, it is also possible to easily calibrate the parts by inputting reference signals from the outside.

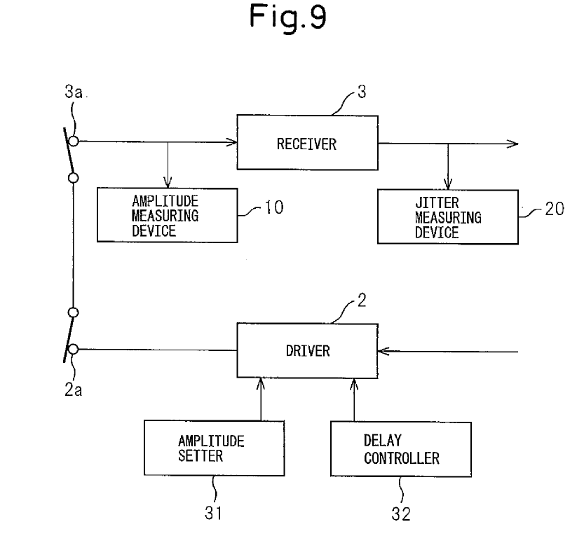

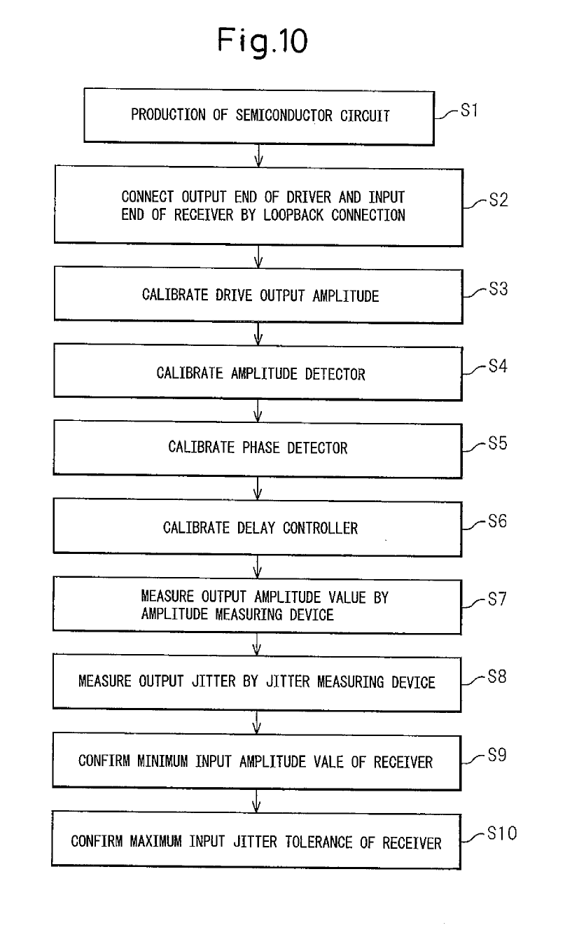

Next, referring to FIGS. 9 and 10, a semiconductor circuit production process including a test process of this embodiment will be explained. FIG. 9 is a block diagram illustrating an electronic device able to perform inspections explained with reference to FIGS. 1 to 3, that is, inspection measuring the output amplitude value, inspection measuring the output jitter, inspection confirming the minimum input amplitude value, and inspection confirming the input jitter tolerance.

As illustrated in FIG. 9, the output of the driver 2 is connected to the input of the receiver 3 by loopback connection. The output amplitude measuring device 10 measuring the output amplitude of the driver 2 is connected to the input of the receiver 3. Further, the output jitter measuring device 20 measuring the output jitter of the driver 2 is connected to the input of the receiver 3. Further, an amplitude setter 31 for setting the amplitude of the driver 2 to the minimum input amplitude of the receiver 3 to check conductivity and a delay controller 32 for controlling the delay to give the maximum jitter tolerance of the receiver 3 to check conductivity are provided.

Next, in accordance with FIG. 10, the flow of the process of production of a semiconductor circuit including the test process of the present embodiment will be explained.

First, a semiconductor circuit in which the circuit illustrated in FIG. 9 is built is produced (S1). Next, in the inspection process, first the output end of the driver 2 and the input end of the receiver 3 are connected by loopback connection (S2). The loopback connection may be connection by an external circuit or connection by an internal circuit.

After loopback connection, the output of the driver 2 is calibrated as explained with reference to FIG. 5 (S3). When the output of the driver 2 finishes being calibrated, the output of the driver 2 is used to calibrate the amplitude detector 11 of the amplitude measuring device 10 explained with reference to FIG. 6 (S4).

Next, the n number of phase detectors 21 of the phase measuring device 20 explained with reference to FIG. 7 are calibrated (S5). When the phase detectors 21 finish being calibrated, the phase detectors 21 are used to calibrate the delay controller 32 explained with reference to FIG. 8 (S6).

After the calibration process ends, as explained with reference to FIG. 1, the output signal of the driver 20 is input through the loopback circuit to the amplitude measuring device where the output amplitude is measured. When the measured output amplitude is in the allowable range or not is judged (S7). Next, as explained with reference to FIG. 3, the output signal of the driver 20 is input through the loopback circuit to the receiver 3, then the signal output from the receiver 3 is input to the jitter measuring device where the jitter of the signal is measured. Whether the measured jitter is in the allowable range or not is judged (S8).

Next, as explained with reference to FIG. 4, the amplitude setter 31 is used to set the amplitude of the driver 2 at the minimum input amplitude of the receiver 3 to check conductivity (S9). Furthermore, the delay controller 32 is used to control the jitter of the driver 2 to the maximum jitter tolerance of the receiver 3 to check conductivity (S10).

In the above way, by building into the semiconductor production process an inspection process of an embodiment, it is possible to perform inspection by measurement of characteristics of semiconductor circuits never performed in the past. In the past, integrated circuits which were produced could also be tested for signal communication, so there were cases of mistaken operation due to noise and other factors after being built into the systems, but according to this embodiment, whether the specifications are satisfied can be judged before shipment. Therefore, it is possible to reduce mistaken operation of integrated circuits after being built into systems. Note that the inspection process can be managed and executed by a computer program.

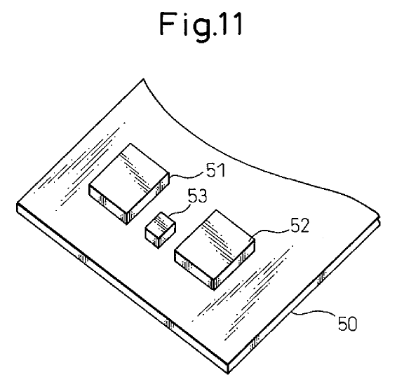

FIG. 11 is a view for explaining a package comprised of an integrated circuit including the measurement circuit of the present embodiment mounted on a printed circuit board. As illustrated in FIG. 11, the printed circuit board 50, for performing the desired processing, mounts integrated circuits 51, 52 including measurement circuits of the present embodiment along with other electronic devices 53 to form a package. Note that other electronic devices required for the package are also provided, but illustration is omitted. If a defect is discovered in a package in which such integrated circuits are assembled, since the individual integrated circuits 51, 52 are provided integrally with their own inspection circuits, it is easy to identify defective devices.

1. An electronic device comprising:
a receiver receiving a signal;
a driver outputting a signal; and
at least one of an amplitude measuring device having an amplitude detector connected to an input end of the receiver and a jitter measuring device having a phase detector connected to an output end of the receiver,
wherein an output end of the driver and an input end of the receiver are connected so as to measure at least one of amplitude and jitter of a driver output.

2. The electronic device as set forth in claim 1, further comprising a loopback circuit to connect the output end of the driver and the input end of the receiver.

3. The electronic device as set forth in claim 1, further comprising an amplitude controller controlling an amplitude of the driver.

4. The electronic device as set forth in claim 1, further comprising a delay controller controlling a delay of the driver.

5. The electronic device as set forth in claim 1, further comprising a first voltage comparator comparing an output of the driver and a reference voltage from the outside to calibrate an output amplitude of the driver.

6. The electronic device as set forth in claim 5, wherein the amplitude measuring device comprises a second voltage comparator comparing a voltage corresponding to a driver output amplitude detected by the amplitude detector and a reference voltage from the outside, and the output of the driver having the calibrated output amplitude is input through the loopback circuit to the amplitude detector, and the amplitude detector is calibrated based on the output of the second voltage comparator.

7. The electronic device as set forth in claim 1, wherein the phase detector of the jitter measuring device has a first input end to receive the output of the receiver and the other input end to receive a phase clock, and an external clock is input to the first input end from outside the electronic device to calibrate the phase detector.

8. An electronic device as set forth in claim 7, wherein after calibration of the phase detector, a predetermined jitter is provided to the driver output by the delay controller, the driver output is input through the loopback circuit to the receiver, and the output of the receiver is input to the first input end of the phase detector to calibrate the delay controller.

9. A circuit board comprising an electronic device as set forth claim 1.

10. A test method for an electronic device comprising a receiver receiving a signal, a driver outputting a signal, and at least one of an amplitude measuring device having an amplitude detector connected to an input end of the receiver and a jitter measuring device having a phase detector connected to an output end of the receiver, the test method comprising:
connecting an output end of the driver and an input end of the receiver;
outputting a signal from the driver;
measuring an amplitude of the signal output from the driver by the amplitude measuring device, if the amplitude measuring device is provided; and
measuring the jitter of the signal output from the driver by the jitter measuring device, if the jitter measuring device is provided.

11. The test method as set forth in claim 10, wherein the connecting the output end of the driver and the input end of the receiver comprises connecting by a loopback circuit provided in the device and connecting the output end of the driver to the output end of the receiver.

12. The test method as set forth in claim 10, further comprising setting an amplitude of the driver to a minimum received amplitude value of the receiver to check communication of the signal output from the driver.

13. The test method as set forth in claim 10, further comprising controlling a delay of the driver to a maximum jitter tolerance of the receiver to check communication of the signal output from the driver.

14. The test method as set forth in claim 10, further comprising comparing an output of the driver and a reference voltage from the outside to calibrate the output amplitude of the driver before the test.

15. The test method as set forth in claim 14, further comprising, after calibration of the output amplitude of the driver, inputting the output of the driver through the loopback circuit to the amplitude detector and comparing the voltage corresponding to the driver output amplitude detected by the amplitude detector and a reference voltage from the outside for calibration of the amplitude detector.

16. The test method as set forth in claim 10, further comprising, before the test, inputting an external clock to input ends of the phase detectors to input an output of the receiver and comparing the phase clocks used at the phase detectors and the external clock for calibration of the phase detectors.

17. The test method as set forth in claim 16, further comprising, after calibration of the phase detectors, providing predetermined jitter to the driver output by the delay controller, inputting the output through the loopback circuit to the receiver, and inputting the output of the receiver to the first input ends of the phase detectors for calibration of the delay controller.

18. A method of production of an electronic device comprising a process of production and a test process,
the process of production for producing a receiver receiving a signal, a driver outputting a signal, and at least one of an amplitude measuring device having an amplitude detector connected to an input end of the receiver and a jitter measuring device having phase detectors connected to an output end of the receiver; and
the test process using the test method comprising:
connecting an output end of the driver and an input end of the receiver;
outputting a signal from the driver;
measuring an amplitude of the signal output from the driver by the amplitude measuring device, if the amplitude measuring device is provided; and
measuring the jitter of the signal output from the driver by the jitter measuring device, if the jitter measuring device is provided.

19. A machine-readable storage medium storing a computer program to perform a test method for an electronic device, the electronic device comprising a receiver receiving a signal, a driver outputting a signal, and at least one of an amplitude measuring device having an amplitude detector connected to an input end of the receiver and a jitter measuring device having a phase detector connected to an output end of the receiver, the method performed after connecting the input end of the receiver and the output end of the driver, the method comprising:
outputting a signal from the driver; and
measuring at least one of an amplitude and phase of the signal output from the driver by at least one of the amplitude measuring device connected to the input end of the receiver and the jitter measuring device connected to the output end of the receiver.

20. The storage medium as set forth in claim 19, the method further comprising:
setting an amplitude of the driver to a minimum received amplitude value of the receiver and outputting a signal from the driver, and/or controlling a delay of the driver to a maximum jitter tolerance of the receiver and outputting a signal from the driver, so as to check communication of the dignal.
